(19) United States
(12) Patent Application Publication
(10) Pub. No.: US 2008/0148050 A1
(43) Pub. Date: Jun. 19, 2008

(54) Content-Carrying Device for Carrying Printed Content That Includes a Key Device Programmed With Information That Enables the Content-Carrying Device to be Used to Access Other Content Via the Key Device

(75) Inventor: Carlton Sparrell, Marblehead, MA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/610,850

(22) Filed: Dec. 14, 2006

(51) Int. Cl. H04L 9/00

(52) U.S. Cl. 713/168

(57) ABSTRACT

A printable or printed content-carrying device, such as, for example, a sheet of photographic paper, has a key device secured to it that is programmed to include or programmable to include information that associates the content-carrying device with content that is related to the content printed on the content-carrying device. A recipient of the content-carrying device may use a key reader to read the information programmed into the key device to access this other related content, which may be stored in electronic form on a storage device at a location designated by the key information.

### TECHNICAL FIELD OF THE INVENTION

The invention relates to a content-carrying device for carrying content that includes a key device that is programmed with information that enables a recipient to access other forms of content via the key device.

### BACKGROUND OF THE INVENTION

The increase in the availability of digital consumer products and services has resulted in an enormous increase in the amount of personal digital content being created by consumers. The term “content” is used by people in the digital industry to describe digital photographs, videos, music, images, audio, data, text, etc. A variety of techniques are available to enable consumers to store and archive various types of digital content files. For example, many consumers use digital cameras and imagers embedded in mobile devices to capture digital image content, which is then stored in memory banks such as flash memory devices, magnetic hard drives and optical storage devices. Consumers typically print hardcopy photographs of a small number of these images. Consumers typically view the majority of the images electronically on digital display devices such as televisions, personal computers (PCs) and mobile devices.

While various techniques and systems are available that enable users to arrange and associate digital images in digital libraries and navigate through the libraries to locate images, disseminating content to enable it to be shared with others presents challenges. Consumers typically use one of three techniques to disseminate content; namely, (1) emailing content to one or more people, (2) creating a web page that people can visit to view and/or hear content, and (3) printing a hardcopy of content and physically disseminating the hardcopy to one or more people. Each of these techniques has disadvantages. The first technique requires a network address of a receiving device (e.g., a computer or mobile device), and the content is generally only viewed on the receiving device. In addition, if a large number of photos need to be sent, they will usually have to be sent as attachments to multiple email communications to ensure delivery.

The second technique requires that the user perform time consuming tasks such as, for example, organizing a web page, transferring content to a web server, organizing an online photo album, etc. This technique is inflexible in that the user generally is not able to tailor the published content to different individuals, i.e, everyone who has access to the web page has the same level of access to the content contained on the webpage. This technique also requires that individuals intended to access the web page retain an address, a URL or some other inconvenient alphanumeric code.

With respect to the third technique, hardcopies can be expensive and inconvenient to create. The user typically must travel to a store or a kiosk and pay to have the hardcopies produced. If the user desires to send hardcopies to many people, many hardcopies will have to be produced and paid for, which can be very time consuming and expensive. This is also true in cases that require hardcopies to be made for movie clips or music selections.

A need exists for a way to disseminate content that is easy, convenient and inexpensive for the disseminator of the content, thereby overcoming the disadvantages discussed above associated with the techniques currently used to disseminate and thereby share content. A need also exists for a way to disseminate content that enables recipients to whom the content is disseminated to easily, conveniently and inexpensively consume the content.

### BRIEF DESCRIPTION OF THE DRAWINGS

FIG. 1 illustrates a diagram that pictorially demonstrates a content-carrying device carrying an image on its upper surface and having a key device embedded in it, as well as a system for reading the key device.

FIG. 2 illustrates a block diagram of the apparatus for producing a hardcopy photograph having the RFID tag embedded in it.

FIG. 3 illustrates another illustrative embodiment in which the apparatus comprises a combined RFID reader and a printer.

FIG. 4 illustrates another illustrative embodiment in which the apparatus comprises a combined printer and RFID reader/writer.

FIG. 5 illustrates a flowchart that represents the method in accordance with an illustrative embodiment for associating content carried on or in a content-carrying device with other electronic content stored in a storage device.

FIG. 6 demonstrates an example of the method described above with respect to FIG. 5 in which the electronic content and an electronic key are delivered electronically to an intended recipient.

FIG. 7 demonstrates an example of the method described above with respect to FIG. 5 in which content and a key device are rendered to a content-carrying device and then physically delivered to an intended recipient by postal delivery, courier, or some other physical delivery technique.

FIG. 8 demonstrates an example of the method described above with respect to FIG. 5 in which an electronic key is obtained by the source from a key provider and then the electronic content and the key are delivered electronically to an intended recipient.

FIG. 9 illustrates a block diagram of the apparatus in accordance with an illustrative embodiment, wherein the key device interface is part of the apparatus.

FIG. 10 illustrates a block diagram of the apparatus in accordance with another illustrative embodiment, wherein the key device interface is external to the apparatus.

### DETAILED DESCRIPTION OF AN ILLUSTRATIVE EMBODIMENT

In accordance with the invention, a content-carrying device, such as, for example, a hardcopy of a photograph, a compact disk (CD) containing music selections, a case that contains the CD, a digital video disk (DVD), a case containing a DVD, etc., has a key device of some type in or on it, such as, for example, an electronic, magnetic, or optical key, which associates the content-carrying device with other content not held on the content-carrying device. For example, the key device on the content-carrying device may associate the content-carrying device with other content stored on (1) a content server connected to the Internet, (2) a computer hard drive of a PC, (3) a magnetic storage device, (4) an optical storage device, (5) some other content-carrying device, (6) a memory device of a mobile device (e.g., a mobile telephone, or personal digital assistant), (7) a memory device of a set-top box, etc.

A user may send the content-carrying device to a recipient, who then uses the content-carrying device to access other content that is associated with the content-carrying device, but not carried on the content-carrying device. For example, a user may send a hardcopy photograph having a radio frequency identification (RFID) tag embedded therein to an intended recipient. The RFID tag is programmed with an association code that associates the tag with other digital photographs that are stored in a storage device at some other location, such as, for example, at a memory address in a content server connected to the Internet. When the recipient places the content-carrying device adjacent an RFID reader, the reader reads the information and uses it to access digital photographs related to the hardcopy photograph that are stored in the content server. The information may include, for example, an identifier that identifies an image library from which the original content originated, the date and time when the original content was created, the location of a server that contains other content associated with the original image, etc. The information typically will also include one or more characteristics associated with the content, such as a description of an event at which the photographs were taken (e.g., Family Vacation, Summer 2006).

Therefore, it is not necessary for the user to send multiple photographs to the intended recipient. Rather, the user may send a single photograph to the recipient who may then use it to access other photographs. Thus, the invention provides a relatively easy and inexpensive solution that overcomes the disadvantages associated with the aforementioned existing content sharing techniques. The recipient is provided with a physical device such as a hardcopy photograph that is easy to locate, handle or otherwise keep track of, which can be easily used to access related content such as related photographs. The sender, who is typically also the creator of the content held on the content-carrying device, is not confronted with having to pay to make multiple hardcopies or with having to send multiple hardcopies to each of the intended recipients. Rather, a single hardcopy can be sent to each intended recipient that is then used by the recipient to access related content.

For ease of illustration and discussion, the content-carrying device will be described herein as a hardcopy photograph bearing image content. The content not held on the content-carrying device that is associated with the content-carrying device will be described herein as being one or more other digital images stored in electronic form on a memory device. It should be noted, however, that the invention is not limited with respect to the type of content-carrying device that is used, or with respect to the type of content that is held by the content-carrying device. The invention also is not limited with respect to the type of content with which the key device is associated, or with respect to the type of key device that is used. The invention also is not limited with respect to the type of memory device in which the associated content is stored.

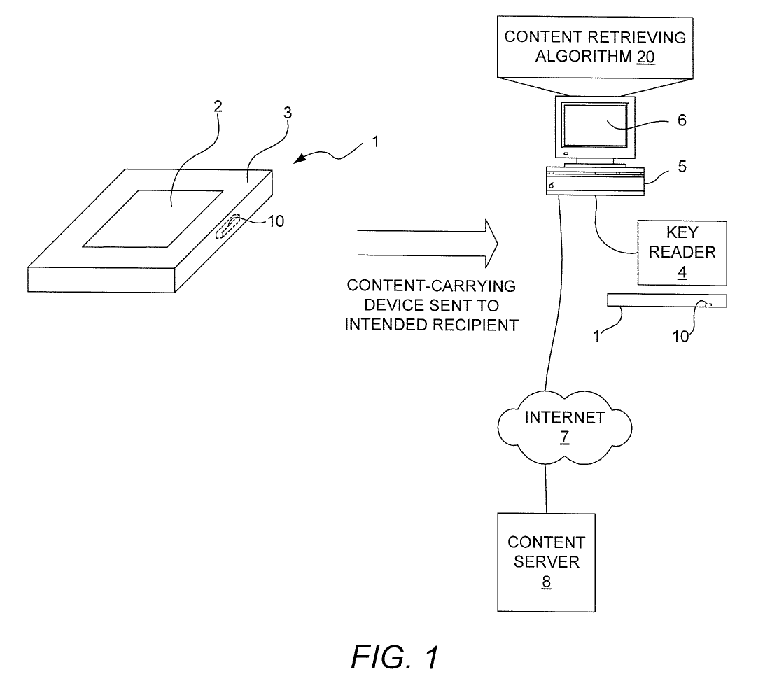

FIG. 1 illustrates a diagram that pictorially demonstrates a content-carrying device 1 bearing an image 2 on its upper surface 3 and having a key device 10 embedded in it. In accordance with this illustrative embodiment, the content-carrying device 1 is a hardcopy photograph and the key device 10 is an RFID tag embedded in the photographic paper that holds the image 2. The user (not shown) sends the hardcopy photograph 1 to an intended recipient (not shown). When the recipient wishes to access content associated with the hardcopy photograph 1, the recipient places the hardcopy photograph 1 adjacent an RFID reader 4. The RFID reader 4 is in communication with a PC 5, which is programmed to execute a software program 20. When the RFID reader 4 reads the identification information off of the RFID tag 10, the PC 5 receives the identification information from the reader 4. The software program 20 then uses the identification information to obtain an address by, for example, using the identification information to index into a lookup table (LUT). Alternatively, the information stored on the RFID tag may comprise an address, such as, for example, a URL. The PC 5 then uses this address or URL to access, via the Internet 7, a content server 8 in which content associated with the hardcopy photograph 1 is stored. The PC 5 receives the content retrieved from the content server 8 and displays the content on the display monitor 6 of the PC 5.

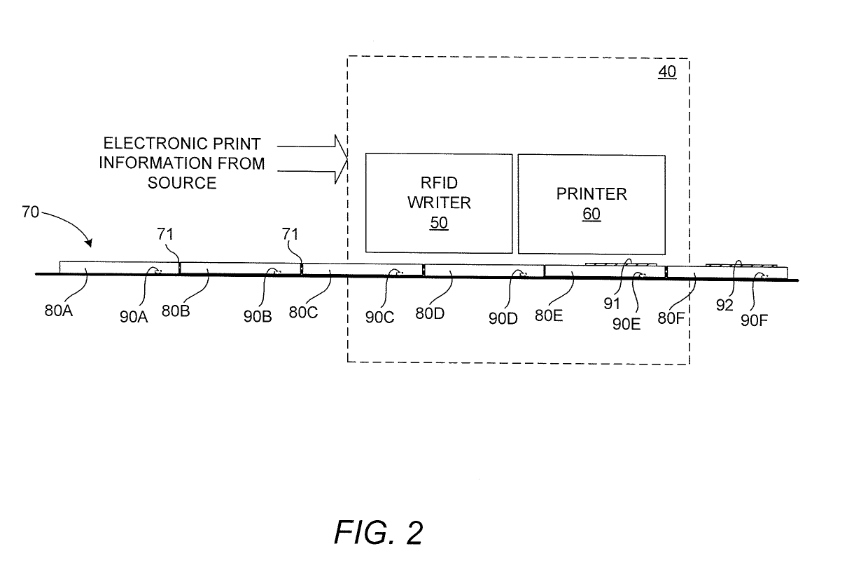

FIG. 2 illustrates a block diagram of the apparatus 40 in accordance with an illustrative embodiment for producing the hardcopy photograph having the RFID tag embedded in it. In accordance with this embodiment, the apparatus 40 is a combination of an RFID writer 50 and a printer 60, such as a laserjet printer, for example. The apparatus 40 prints images on sheets of paper 70 that are perforated with perforations 71 to allow multiple images to be printed on each sheet and then separated into respective hardcopies. The perforations 71 provide the dividing boundaries between paper regions 80A-80G, each of which has a respective RFID tag 90A-90G embedded in it. The sheet 70 may also have fold lines (not shown) or perforations (not shown) in the direction of the feed and perpendicular to the direction of the perforations 71, which would allow the sheet to be divided into many more paper regions than what is represented by regions 80A-80G. These additional paper regions may or may not include RFID tags.

With reference to FIG. 2, electronic digital image information to be printed is received by the apparatus 40 from some device in communication with the apparatus, such as, for example, a PC, a camera, a cable television set-top box, a mobile phone, etc. The RFID writer 50 programs each RFID tag with information associated with the image to be printed on the corresponding paper region. For example, the RFID tag 90F is programmed by the writer 50 with information that associates the RFID tag 90F with the image 92 printed on the paper region 80F and that associates the image 92 with other content stored on some other storage device (not shown). This association information may be provided to the apparatus 40 along with or separately from the electronic digital information corresponding to the image to be printed. Subsequently, the region 80F is separated from the sheet 70 as a photograph and sent to an intended recipient who can use the photograph to access other content stored in some storage device at an address designated by the information stored on the RFID tag 90F.

It should be noted that, instead of programming the RFID tags during the printing process, the RFID tags may be programmed before or after printing of the images. If the RFID tags are programmed before or after printing rather than during printing, the apparatus 40 need not include the RFID writer 50. If the RFID tags are programmed before printing, some type of registration mechanism or algorithm is needed to ensure that each image is printed on the paper region having the RFID tag that has been programmed with information associating the tag with that particular image. This can be accomplished in a variety of ways, as will be understood by those skilled in the art. For example, if the printer 60 is provided with a priori information about the order of RFID tags in the sequence of paper regions to be printed, the printer 60 may execute an algorithm that maintains a count of the number of paper regions that have been printed and uses that count to determine the next image to be printed. The printer 60 would then print that image on the paper region in which the associated RFID tag is embedded.

If the RFID tags are programmed after printing has been performed, some type of registration process or algorithm will need to be performed to ensure that the RFID tags are programmed by the RFID writer with the correct information to associate the RFID tags with the images printed on the paper regions in which the tags are embedded. As will be understood by those skilled in the art, this can be accomplished in a variety of ways. For example, the RFID writer (not shown) that follows the printer 60 may communicate with the printer 60 to coordinate programming of the RFID tags to the image sequence being output from the printer 60.

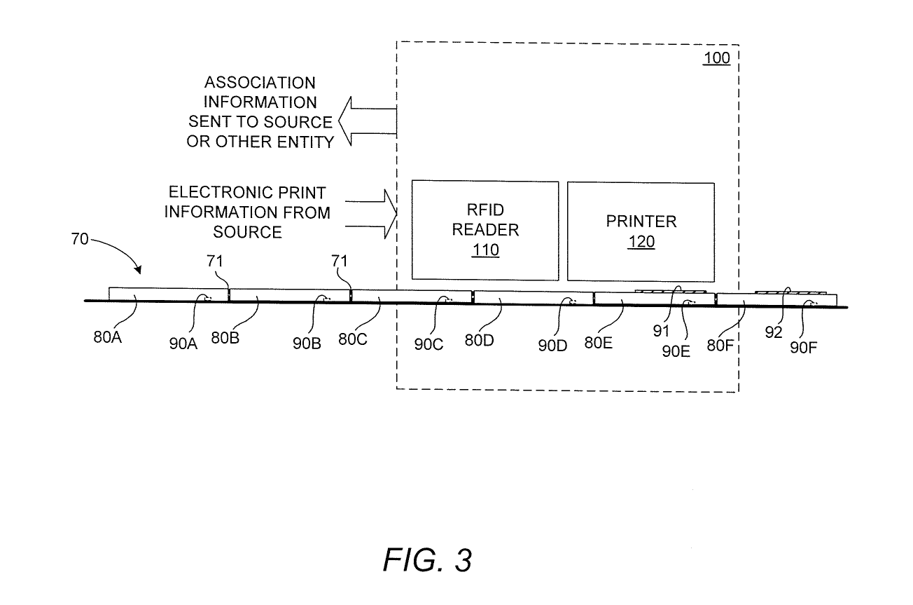

FIG. 3 depicts another illustrative embodiment in which the apparatus 100 comprises a combined RFID reader 110 and a printer 120. In accordance with this embodiment, the RFID tags are programmed prior to the print process being performed. The RFID reader 110 reads the RFID information from the RFID tags as they are moved into proximity with the reader 110. As each image is printed on the corresponding paper region, the apparatus 100 communicates the association between the RFID tag embedded in the paper region and the image printed on the paper region back to the source of the electronic image information (i.e., back to the PC, camera, set-top box, mobile phone, etc.) that sent the information to the printer 120. Alternatively, the association information may be communicated to some other entity, such as a clearinghouse, for example, that performs the function of associating the printed images with corresponding RFID tags. When the source or other entity receives this information, it associates the RFID information with the corresponding printed image, which typically comprises associating the RFID information and/or the printed image with a location where other content associated with the printed image resides. As described above with reference to FIG. 1, once the association between the RFID information and this other content has been made, a recipient of the hardcopy photograph may use an RFID reader to read the RFID tag embedded in the hardcopy photograph to cause the associated content to be retrieved and displayed to the recipient on some type of rendering device.

Although FIGS. 2 and 3 depict the RFID writer 50 and the RFID reader 110 as being devices that are separate from the printers 60 and 120, respectively, this is not necessarily the case. A printer may be constructed that includes an RFID reader or an RFID writer, or a combination RFID reader/writer. In this way, the printer and the RFID reader and/or writer may share common circuitry, such as, for example, a microprocessor, memory, etc. It should also be noted that the invention is not limited with respect to the type of printer that is used to make the hardcopies. The invention also is not limited with respect to the type of paper that is used by the printer. The paper may be, but is not limited to, cardstock, photographic paper, stickers, textile material (e.g., cloth or fabric), and other materials.

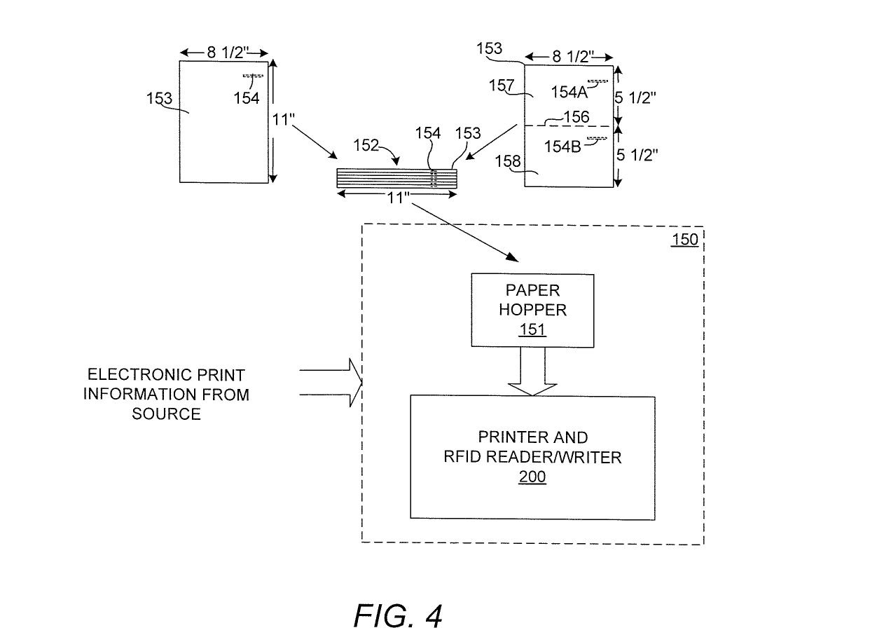

FIG. 4 depicts another illustrative embodiment in which the apparatus 150 comprises a combined printer and RFID reader/writer 200. The apparatus 150 may operate in any of the manners described above with respect to FIGS. 2 and 3. In accordance with this embodiment, the paper to be printed on is held in a hopper 151 from which it is fed by a feed mechanism (not shown) into the combined printer and RFID reader/writer 200. The hopper 151 is capable of holding a stack 152 of paper sheets 153, each of which has at least one RFID tag 154 embedded therein. The sheets 153 may be, for example, 8½ inch by 11½ inch sheets having a single RFID tag 154 embedded therein. Each 8½ inch by 11½ inch sheet may be perforated with a perforation 156 such that each sheet 153 is dividable into, for example, two 8½ inch by 5½ inch sheets 157 and 158, each of which has a respective RFID tag 154A and 154B embedded therein.

When a sheet 153 is received in the combined printer and RFID reader/writer 200, the RFID reader detects the RFID tags 154A and 154B. If the RFID tags have previously been programmed, the apparatus 150 is able to determine which images are to be printed on the sheets 153 or on the subdivided sheets 157 and 158. To do this, the apparatus 150 is provided with information from the source as to which images are to be associated with which RFID tags. In this case, when the RFID tag is read, the apparatus 150 will cause the image corresponding to the information read from the RFID tag to be queued so that the printer prints the image associated with the RFID tag on the sheet or subdivision of the sheet in which the RFID tag is embedded. In cases where the RFID tags have not been previously programmed to include information that associates selected content with particular tags, the tags may still have some information programmed into them to inform the apparatus 150 about certain characteristics of the paper, such as, for example, the number of perforated subdivisions per sheet, the size of the perforated subdivisions, the orientation of the sheets, the size of the print regions within each subdivision, etc.

In the case where only a few (e.g., two) different images are being printed on all of the sheets 153, and each of the sheets 153 is subdivided into a few (e.g., two) sheet subdivisions 157 and 158, the orientation of the sheets 153 in the hopper 151 and/or the orientation of the sheets when they are loaded into the combination RFID reader/writer and printer 200 from the hopper 151 may be used by the apparatus 150 to distinguish sheet subdivisions 157 and 158 from each other. In this case, it is unnecessary for the RFID tags to have been previously programmed to enable the subdivisions 157 and 158 to be distinguished from each other. The RFID reader portion detects the presence of the RFID tag and the RFID writer portion writes information to the tag that identifies the tag as being embedded in either sheet subdivision 157 or 158. This information is passed along to the printer portion, which uses the information to ensure that the correct image is printed on the correct sheet subdivision. If the source of the electronic image information has not previously (i.e., prior to printing) associated the image to be printed with the RFID tag information, this information may be sent from the apparatus 150 to the source to enable the source to make the association.

The RFID reader/writer portion of the combination RFID reader/writer and printer 200 may configured as a short range RFID reader/writer and attached to or otherwise made part of the print head so that the RFID tags can be read and/or written when the print head is moved in its typical boustrophedonic scan pattern. Alternatively, the RFID reader/writer may be mounted on its own scanning mechanism (not shown) to allow it to scan the document and read and/or write the RFID tags. The RFID reader/writer may also be fixedly positioned in the apparatus 150 and use an addressable RF antenna (e.g., a phased array) to detect and read/write the RFID tags. In any case, the processes of printing the image and writing the RFID device may occur simultaneously or during non-overlapping or partially overlapping time intervals. The hopper 151 may be shielded from RF signals, if necessary, to prevent the RFID tags on the sheets 153 loaded in the hopper 151 from being detected. Such shielding can be accomplished by using, for example, a Faraday cage, as is well understood by those skilled in the art.

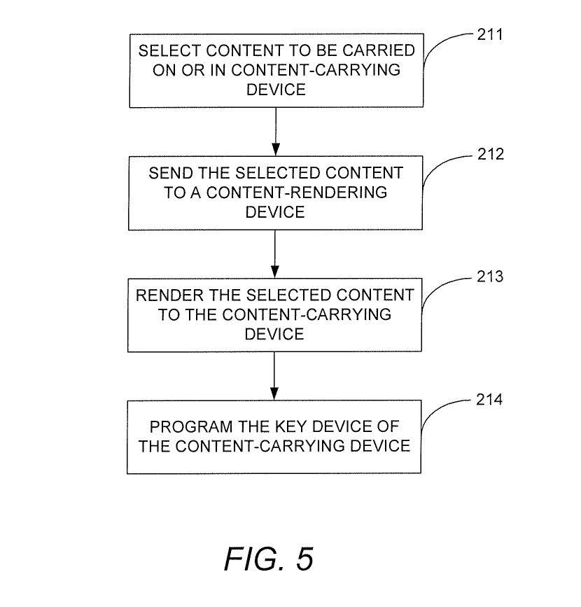

FIG. 5 illustrates a flowchart that represents the method in accordance with an illustrative embodiment for associating content carried on or in a content-carrying device with other electronic content stored in a storage device. The content to be carried by the content-carrying device is selected by the user, as indicated by block 211. An example of this step is a user selecting a digital image to be used to represent a group of images of an electronic digital photo album. At some later point in time, the selected content is sent to a rendering device that will physically render the content, as indicated by block 212. An example of this step is a PC sending a digital image to a printer, which functions as the content-rendering device. The term “content-rendering device”, as that term is used herein, is intended to denote any device that is capable of receiving content in electronic or physical form and placing the content on or in the content-carrying device. Examples of content rendering devices include, for example, printers, CD writers, DVD writers, CD case manufacturers and distributors, DVD case manufacturers and distributors, etc.

The selected content is placed on or in the content-carrying device having the key device attached or secured thereto or embedded therein, as indicated by block 213. An example of this step is a printer printing the selected image on a sheet of photographic paper having an RFID tag embedded in it. The key is written or programmed with information that describes an association between the key and electronic content stored in electronic form in some type of storage device at some location, as indicated by block 214.

By associating the key device with this electronic content, the electronic content also becomes associated with the content-carrying device of the content-carrying device. Therefore, the associating step represented by block 214 may be viewed as associating the key device with the electronic content and/or as associating the content-carrying device with the electronic content. In any event, the key device is programmed or written with information that will allow the recipient to access the electronic content. The key information may be an electronic access number, such as, for example, a URL of a web server or a memory address where the electronic content is stored. Alternatively, the key information may be an index to a LUT that contains an electronic access number such as a URL or other memory address.

The steps represented by the blocks shown in FIG. 5 are not limited to being performed in any particular order. In particular, as described above with reference to FIGS. 2-4, the key may be written or programmed at anytime, e.g., before the image information to be printed is sent from the source to the printer, after the image has been printed, during printing of the image, etc. Thus, it is not necessary for the step represented by block 214 to be performed in any particular order relative to the other steps represented by blocks 211-213. The invention also is not limited with respect to when the key device is attached to, secured to, placed on, or embedded in the content-carrying device. It should also be noted that although the invention has been described with reference to the key device being on or in the content-carrying device, this is intended to include cases where the key device is on or in the content itself carried on the content-carrying device.

In addition, although the associated content that is not carried on the content-carrying device has been described herein as electronic content, i.e., content in electronic form, the associated content may instead by physical content. For example, an RFID tag on a hardcopy photograph may associate the hardcopy photograph with a batch of hardcopy photographs waiting to be picked up by an intended recipient at a store where the group of hardcopy photographs was developed. In this case, an RFID reader at the store reads the RFID tag on the hardcopy photograph and communicates with a computer at the store that identifies a batch of hardcopy photographs associated with the RFID tag.

As indicated above, the invention is not limited to any particular type of content or content-carrying device. The invention also is not limited to any particular type of key devices. Although the invention has been described with reference to using RFID tags, other types of key technologies may be used for this purpose, such as, for example, barcoding. When RFID tags are used and paper is used as the content-carrying device, the RFID tags may be embedded during the paper manufacturing process, such as by adding them to the paper pulp slurry prior to the moisture being removed from the slurry. Alternatively, the RFID tags may be added after the paper manufacturing process has been completed, such as by printing the tags on the paper using ink-based circuitry or adhering the tags to the surfaces between paper layers. Preferably, flexible RFID circuitry is used that is suitable for being fed through a laser printer, a laserjet printer, and inkjet printer, etc.

The term “source” has been used herein so far to describe an entity that sends the content to be carried on or in the content-rendering device to the content renderer, e.g., a printer machine. The source is typically a person who played some role in creating the content, such as a person who uses a digital camera to take digital photographs. That person may then download the digital photographs to a PC and subsequently cause the photographs to be printed on paper having RFID tags embedded therein by a printer connected to the PC. That same person may then cause some or all of the photographs to be uploaded to a webpage at an address that is identified directly or indirectly by the information stored on the RFID tag. That same person may then send a representative one of the hardcopy photographs to an intended recipient who, by placing the hardcopy near an RFID reader, accesses the photographs contained on the webpage and causes them to be displayed on a display device, e.g., a PC display monitor, a mobile phone display screen.

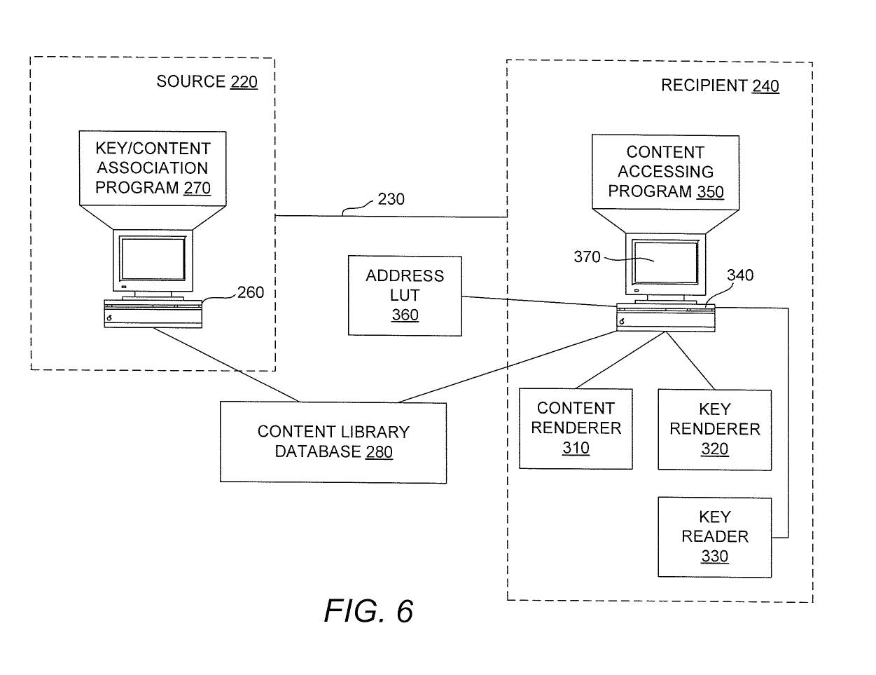

The tasks that have been described herein as being performed by the “source” may be distributed over multiple entities such that the source from which the content renderer receives the selected content may be a different source from the source that caused the content to originally be created. Thus, the term “source”, as that term is used herein, is intended to denote any entity from which the content renderer directly or indirectly receives the selected content to be rendered. Also, in the case where the content renderer communicates association information back to the source to enable the source to create an association between the rendered content and other associated content, the source may be any entity that makes the association, and not necessarily the entity that caused the content to originally be created and/or sent to the content renderer. FIGS. 6-8 depict a few examples of different scenarios for carrying out the method described above with reference to FIG. 5.

FIG. 6 demonstrates an example of the method described above with respect to FIG. 5 in which the electronic content and an electronic key are delivered electronically to an intended recipient. An example of case in which this embodiment is useful is as follows. A son sends an electronic key and electronic photographic content via email to his mother, who is fairly knowledgeable about technology. The mother then causes the content to be printed on photographic paper having a key device embedded therein and using a printer and causes the electronic key to be written with information that associates the content with other photographic images stored in some storage device. The mother can now use the hardcopy photograph to access the other associated electronic content, and may send the hardcopy photograph to others who can also use it to access the other associated content. In addition, the mother sends the photograph to her mother (the son's grandmother) who is not familiar enough with the technology needed to perform the functions of printing the image and writing the association information to the key device.

The source 220 (e.g., the son) selects the content to be rendered and an electronic key to be associated with the selected content and sends the selected content and the electronic key over a wired or wireless communications link 230 to an intended recipient 240 (e.g., the mother). In this case, the key may be, for example, a title, a URL, an IP address, a Universal ID, an authentication certificate, etc. The source 220 may generate the key or obtain the key from some other entity. Prior to or after selecting and sending the selected content and key to the intended recipient, the source 220 associates the content to be rendered and other related content with the key and stores the association in a memory device (not shown). To accomplish this, the source 220 may use a PC 260 that executes a key/content association software program 270 that allows the user to peruse a content library database 280, select content to be associated with a key, generate or select a key, perform the association function, and store the association in a memory device, which may be internal to the PC 260. The database 280 may be contained in memory device of the PC 260 or in some other memory device at the source 220 or at some other location.

The recipient 240 uses a content renderer 310, such as a printer, for example, to render the content and key to a content-carrying device. The recipient 240 uses a key renderer 320, such as an RFID writer, for example, to render the electronic key to the content-carrying device. The process of rendering the electronic key may include physically attaching the key device to the content-carrying device and/or programming the key device. In the case where the content-carrying device is photographic paper, the recipient typically will purchase photographic paper already having key devices, such as RFID tags, embedded therein. In this case, the process of rendering the key performed by the recipient 240 is typically limited to writing the electronic key to the key device.

The recipient 240 uses a key reader 330 such as an RFID reader to read the key. The key reader 330 then forwards the key information to a PC 340. The PC 340 executes a content accessing program 350 that uses the information read from the key to access an address LUT 360, which may be at the source 320 or at some other location. The PC 340 then uses the address obtained from the LUT 360 to access and retrieve the associated content, which may be stored in the content library database 280. The retrieved content may be rendered by a rendering device such as, for example, a display monitor 370 controlled by the PC 340 or the content renderer 310.

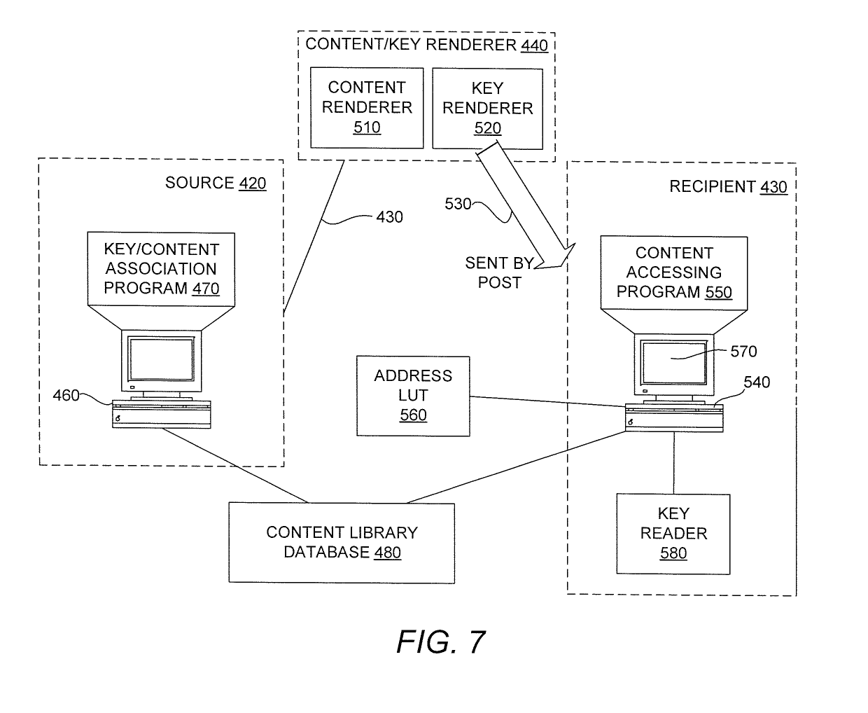

FIG. 7 demonstrates an example of the method described above with respect to FIG. 5 in which content and a key device are rendered to a content-carrying device and then physically delivered to an intended recipient by postal delivery, courier, or some other physical delivery technique. The source 420 selects content and an electronic key to be rendered and sends the selected content and an electronic key over a wired or wireless communications link 430 to content and key renderer 440. The source 420 may generate the key or obtain the key from some other entity. Prior to or after selecting and/or sending the selected content and key to the content/key renderer 440, the source 420 uses a PC 460 that executes a key/content association software program 470 that allows the source 420 to peruse a content library database 480, select content to be associated with a key, perform the association function, and store the association in memory in the PC 460.

The content/key renderer 440 comprises a content rendering device 510, such as a printer, for example, to render the content and the key to a content-carrying device. The content/key renderer 440 comprises a key rendering device 520, such as an RFID writer, for example, that programs the key device. The content-carrying device having the content and the programmed key is then physically delivered via some form of physical delivery 530 to the intended recipient 430. The recipient 430 uses a key reader 580, such as an RFID reader, for example, to read the key information from the key device. The key reader 580 forwards the key information to a PC 540. The PC 540 executes a content accessing program 550 that uses the information read from the key to access an address LUT 560, which may be at any location. The PC 540 then uses the address obtained from the LUT 560 to access and retrieve the associated content, which may be stored in the content library database 480. The retrieved content may be rendered by a rendering device such as, for example, a display monitor 570 controlled by the PC 540 or some other rendering device, such as a printer (not shown) controlled by the PC 540.

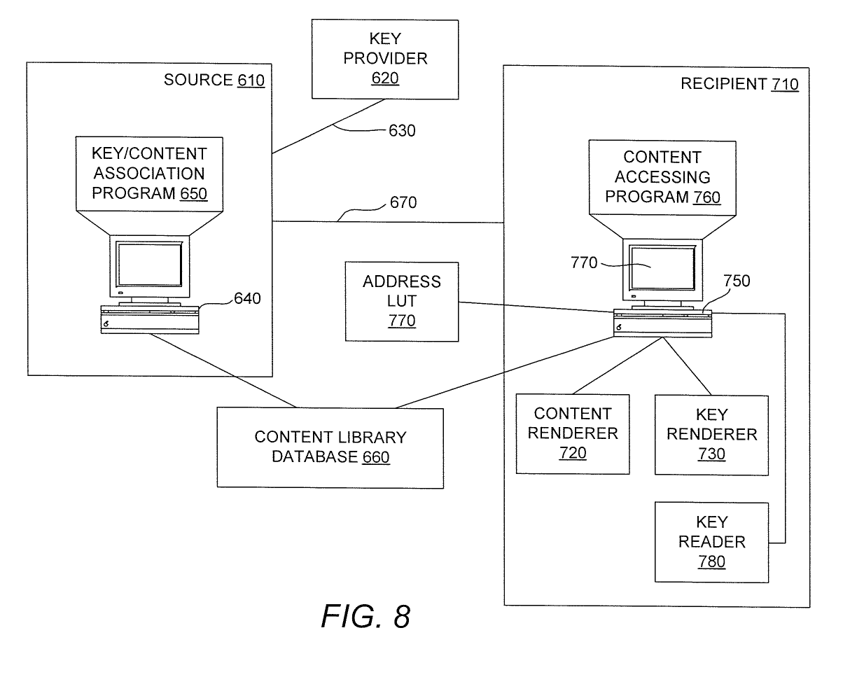

FIG. 8 demonstrates an example of the method described above with respect to FIG. 5 in which an electronic key is obtained by the source from a key provider and then the electronic content and the key are delivered electronically to an intended recipient. The source 610 selects the content to be rendered and requests an electronic key from a key provider 620. The key is requested and delivered via a wired or wireless communications link 630. As with the examples given above, the key may be, for example, a title, a URL, an IP address, a Universal ID, an authentication certificate, etc. The source 610 associates the selected content to be rendered and other related content with the key and stores the association in a memory device (not shown). To accomplish this, the source 610 may use a PC 640 that executes a key/content association software program 650 that allows the user to peruse a content library database 660, select content to be associated with the key, perform the association function, and store the association in a memory device, which may be internal to the PC 640. The content and the key are then sent in electronic form over a wired or wireless link 670 to an intended recipient 710.

The recipient 710 uses a content renderer 720, such as a printer, for example, to render the content to a content-carrying device. The recipient 710 uses a key renderer 730, such as an RFID writer, for example, to write the electronic key to the key device on the content-carrying device. These tasks may be accomplished in the manner described with reference to FIG. 4, for example, by writing the electronic key to an RFID device embedded in a sheet of photographic paper as the electronic image is printed on the sheet of photographic paper. The programmed key device is then read by a key reader 740, which may be accomplished by, for example, placing the content-carrying device having the content and the programmed key device thereon adjacent the key reader 740. The key reader 740 reads the key information from the key device and forwards the key information to a PC 750. The PC 750 executes a content accessing program 760 that uses the information read from the key device to index into an address LUT 770. The PC 760 then uses the address obtained from the LUT 770 to access and retrieve the associated content, which may be stored in the content library database 660. The retrieved content may be rendered by a rendering device such as, for example, a display monitor 780 controlled by the PC 750 or the content renderer 720.

The embodiments described above with reference to FIGS. 6-8 are only a few examples of the many ways in which the invention may be implemented. Those skilled in the art will understand that many variations may be made to the embodiments described herein and that all such variations are within the scope of the invention. For example, although PCs are shown in FIGS. 6-8, the functions performed by the PCs may be performed by processors embedded in various types of devices, such as, for example, smart printers, set top box digital cable decoders, smart television sets, etc.

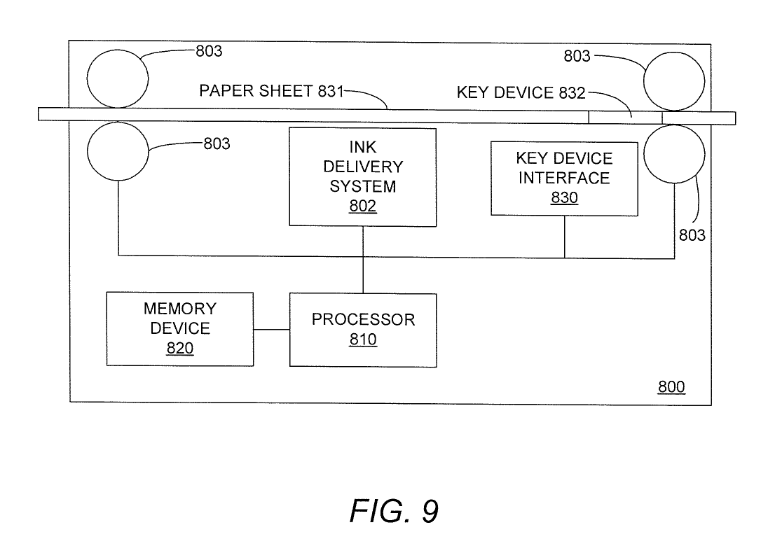

FIG. 9 illustrates a block diagram of the apparatus 800 in accordance with an illustrative embodiment. The apparatus 800 may be any one of the apparatus 40, 100 and 150 shown in FIGS. 2-4, and any one of the PCs 260, 340, 460, 540, 640 and 750 shown in FIGS. 6-8. The apparatus 800 has a processor 810, a memory device 820, a key device interface 830, an ink delivery system 802, and a paper sheet feeding system comprising rollers 803. The processor 810 communicates with all of the other components 801, 802, 803, 820, and 830 to perform the functions described above with reference to FIGS. 2-4. The key device interface 830 may be a key device reader, a key device writer, or a combination key device reader/writer.

A sheet of paper 831 having a key device 832 embedded in it or on its surface is moved through the apparatus 800 by the paper feeding system 803 in accordance with signals delivered to it by the processor 810. The ink delivery system 802 prints images on the paper in accordance with signals delivered to it by the processor 800. In the case in which the key device interface 830 is a key reader, the key reader reads the key device 832 and outputs signals to the processor 810. The processor 810 processes these signals and outputs control signals to one or both of the paper feeding system 803 and the ink delivery system 802 to control the location at which the image is printed and/or the content that is printed.

In the case in which the key device interface 830 is a key device writer, the writer causes association information to be written to the key device 832. The processor 810 may output control signals to the key device interface 830 to control the information that is written to the key device 832 and/or to control the timing of writing information to the key device 832.

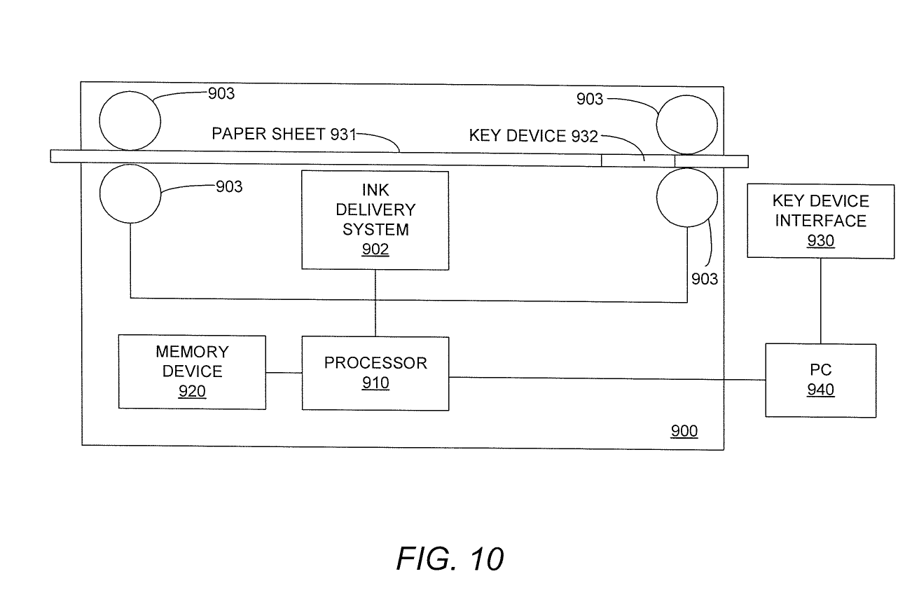

FIG. 10 illustrates a block diagram of the apparatus 900 of the invention in accordance with an illustrative embodiment. In contrast to the embodiment described above with reference to FIG. 9, the key device interface 930 shown in FIG. 10 is external to the apparatus 900. The key device interface 930 is in communication with a PC 940, which is in communication with the processor 910. The key interface device 930 may be a key device reader, a key device writer, or a combination key device reader/writer. The other components 902 and 903 shown in FIG. 10 may be identical to the components 802 and 803, respectively, shown in FIG. 9. The key device interface 930 reads and/or writes the key device 932 that is on or in the sheet of paper 931 after the image has been printed by the ink delivery system 902 and the paper feeding system 903 has moved the paper sheet 931 partially or wholly out of the apparatus 900. The PC 940 controls the key device interface 930 and communicates with the processor 910 of the apparatus 900.

The processors 810 and 910 may each be any type of computational device including, for example, a microprocessor, a microcontroller, a programmable logic array, a programmable gate array, an application specific integrated circuit (ASIC), etc. The processors 810 and 910 may be implemented solely in hardware or in a combination of hardware and software or firmware.

The memory devices 820 and 920 may be used to store any computer instructions that are executed by the processor 810 and 910, such as, for example, programs 270 and 350 shown in FIG. 6, and data, such as, for example, content and information associating keys with content. The memory devices 820 and 920 may each be any type of computer-readable medium including, for example, random access memory (RAM), read only memory (ROM), flash memory, compact disks (CDs), digital video disks (DVDs), magnetic disks, magnetic tapes, etc. The invention also encompasses signals modulated on wired and wireless carriers in packets and in non-packet formats.

The invention has been described with reference to a few illustrative embodiments. It should be noted, however, that the invention is not limited to the embodiments described herein. As will be understood by those skilled in the art, the invention can be implemented in many different forms. The embodiments described herein are only examples of a few ways in which the invention may be implemented. Persons skilled in the art will understand, in view of the description provided herein, that many variations may be made to the embodiments described herein and all such variations are within the scope of the invention.

What is claimed is:

1. A content-carrying device comprising:
a substrate material having at least one surface for printing content thereon; and
a key device on or in the substrate material, wherein the key device is programmable to include information that associates the content-carrying device with other related content not carried on the content-carrying device.

2. The device of claim 1, wherein the content-carrying device is a sheet of paper.

3. The device of claim 2, wherein the content-carrying device is a sheet of photographic paper.

4. The device of claim 1, wherein the content-carrying device is a sticker, and wherein a surface of the substrate material includes an adhesive material.

5. The device of claim 1, wherein the content-carrying device is a case for carrying a storage medium.

6. The device of claim 1, wherein the content-carrying device is an optical disk.

7. The device of claim 1, wherein the key device is a radio frequency identification (RFID) integrated circuit (IC) device.

8. The device of claim 1, wherein the key device is a barcode.

9. The device of claim 1, wherein said information includes information that identifies an address in a memory device where said other related content is stored.

10. The device of claim 1, wherein said information includes information that identifies a uniform resource locator (URL) for network component that contains said other related content.

11. The device of claim 1, wherein said information includes information that identifies at least one characteristic of said other related content.

12. The device of claim 1, wherein said information includes information that indicates whether the substrate material includes at least one perforation for dividing the substrate material into two or more subdivisions in which two or more respective images are to be printed.

13. The device of claim 1, wherein said information includes information that indicates an orientation of the substrate material.

14. The device of claim 1, wherein said information includes information that indicates the size of the substrate material in at least one dimension.

15. A content-carrying device comprising:
a substrate material having at least one surface for printing content thereon; and
a key device on or in the substrate material, wherein the key device is programmed to include information that associates the content-carrying device with other related content not carried on the content-carrying device.

16. The device of claim 15, wherein the content-carrying device is a sheet of paper.

17. The device of claim 15, wherein the content-carrying device is a sheet of photographic paper.

18. The device of claim 15, wherein the content-carrying device is a sticker, and wherein a surface of the substrate material includes an adhesive material.

19. The device of claim 15, wherein the content-carrying device is a case for carrying a content-carrying device.

20. The device of claim 15, wherein the content-carrying device is an optical disk.
